(19) United States
(12) Patent Application Publication
(10) Pub. No.: US 2004/0190747 A1
(43) Pub. Date: Sep. 30, 2004

(54) Magnetic shielding of loud speaker sensing coil

(76) Inventor: Toshio Chikama, Tokyo (JP)

Correspondence Address: OSHA & MAY L.L.P., 1221 MCKINNEY STREET, HOUSTON, TX, 77010, US

(21) Appl. No.: 10/484,559

(22) PCT Filed: Jul. 8, 2002
(86) PCT No.: PCT/JP02/06920

(30) Foreign Application Priority Data
Jul. 23, 2001 (JP) 2001-221189

(51) Int. Cl. H04R 1/00; H04R 9/06; H04R 11/02

(52) U.S. Cl. 381/401; 381/407

(57) ABSTRACT

In order to prevent electric current from being induced in accordance with variation of magnetic force of a voice coil so that dynamic characteristics of a speaker are enhanced, a magnetic shielding member 1 composed of a magnetic material is disposed between the voice coil 12 and a detection coil 13. And by flowing magnetic force lines generated at the voice coil 13 to the magnetic shielding member 1, the magnetic force lines are prevented from reaching the detection coil 13.

### TECHNICAL FIELD

This invention relates to a speaker which is designed such that a detection signal of detection coil is negatively fed back to the input side of a voice coil.

### BACKGROUND ART

In general, in a speaker of the type in which a diaphragm is vibrated by a voice coil, a detection coil is axially arranged with the voice coil and connected to the voice coil such that the detection coil is integrally moved with the voice coil in the direction of the axis of the voice coil. Accordingly, the detection coil is vibrated in accordance with vibration of the voice coil to thereby generate a dynamic electric current at the detection coil. By feeding this dynamic electric current back to the input side of the voice coil, the dynamic characteristics of the speaker can be improved.

However, in the conventional speaker, dynamic electric current occurs at the detection coil and in addition, dynamic electric current also occurs under the effect of mutual induction caused by variation of the electric current flowing to the voice coil. This electric current caused under the effect of mutual induction is also fed back to the input side of the voice coil. As a result, the amount of feedback electric current caused by dynamic electric current is reduced. Therefore, the improvement of the dynamic characteristics of the speaker is prevented to that effect.

### DISCLOSURE OF THE INVENTION

The present invention has been made in order to solve the above-mentioned problem.

According to the present invention, there is provided a speaker comprising a voice coil for driving a diaphragm, a detection coil connected to the voice coil with the axis thereof generally aligned with that of the voice coil and in a manner capable of moving in the axial direction in unison with the voice coil, a first magnetic field feed means for feeding a magnetic field to the voice coil, and a second magnetic field feed means for feeding a magnetic field to the detection coil, wherein the speaker further comprising a magnetic shielding member composed of a magnetic material; the magnetic shielding member being disposed between the voice coil and the detection coil and adapted to prevent a magnetic force line generated by the voice coil from being bound for the detection coil side.

It is preferable that the speaker further comprises a cylindrical bobbin one end of which is attached with the diaphragm, the voice coil and the detection coil being spacedly arranged on an outer periphery of the bobbin in the direction of the axis of the bobbin.

It is also preferable that the bobbin is provided with a plurality of cutout parts which are spacedly arranged thereon in the peripheral direction and extending from an intermediate part between the voice coil and the detection coil to the other end face of the bobbin, thereby an arm part being formed between every two adjacent cutout parts in the peripheral direction, the magnetic shielding member being disposed between the voice coil and the detection coil in the direction of the axis of the bobbin, the same number of insertion holes as the number of the arm parts being formed in the magnetic shielding member, the arm parts being inserted in the corresponding insertion holes with spaces, respectively.

Preferably, the magnetic shielding member and a magnetic pole piece constituting a part of a magnetic circuit for the detection coil are arranged in adjacent relation in the direction of the axis of the voice coil, and a spacer composed of a nonmagnetic material is disposed between the magnetic shielding member and the magnetic pole piece.

It is preferable that the magnetic shielding member includes an annular outer member disposed at the outside of the bobbin with a space formed between said outer member and an outer peripheral surface of the bobbin and an inner member disposed at the inside of the bobbin with a space formed between the inner member and an inner peripheral surface of the bobbin in such a manner as to oppose said outer member with the bobbin disposed therebetween, a magnetic fluid being disposed between the outer member and the bobbin and another magnetic fluid between the inner member and the bobbin, respectively.

It is also preferable that a correction coil for reducing an induction current induced to the detection coil in accordance with variation of current flowed into the voice coil is disposed generally coaxially with the voice coil and the detection coil.

### BRIEF DESCRIPTION OF DRAWINGS

FIG. 1 is a view showing the first embodiment of the present invention, FIG. 1(A) is a vertical sectional view thereof, FIGS. 1(B), 1(C) and 1(D) are sectional views taken on lines B-B, C-C and D-D of FIG. 1(A), respectively.

FIG. 2 is a circuit diagram of a speaker apparatus in which the speaker shown in FIG. 1 is used.

FIG. 3 is a vertical sectional view showing the second embodiment of the present invention.

FIG. 4 is a vertical sectional view showing the third embodiment of the present invention.

FIG. 5 is a vertical sectional view showing the fourth embodiment of the present invention.

FIG. 6 is a view showing the fifth embodiment of the present invention, FIG. 6(A) is a vertical sectional view thereof, and FIG. 6(B) is a sectional view taken on line B-B of FIG. 6(A).

FIG. 7 is a vertical sectional view showing the sixth embodiment of the present invention.

FIG. 8 is a vertical sectional view showing the seventh embodiment of the present invention.

FIG. 9 is a view showing the eighth embodiment of the present invention, FIG. 9(A) is a vertical sectional view thereof, and FIG. 9(B) is a sectional view taken on line B-B of FIG. 9(A).

FIG. 10 is a sectional view taken on line X-X of FIG. 9(A).

FIG. 11 is a sectional view taken on line Y-Y of FIG. 9(A).

FIG. 12 is a view showing one example of a circuit of a speaker apparatus in which the speaker shown in FIGS. 9 through 11 is used.

FIG. 13 is a view showing another example of a circuit of a speaker apparatus in which the speaker shown in FIGS. 9 through 11 is used.

FIG. 14 is a vertical sectional view showing the ninth embodiment of the present invention.

FIGS. 15(A), 15(B) and 15(C) are sectional views taken on lines X-X, Y-Y and Z-Z of FIG. 14, respectively.

FIG. 16 is a view showing the tenth embodiment of the present invention, FIG. 16(A) is a vertical sectional view thereof, FIGS. 16(B) and 16(C) are sectional views taken on lines B-B and C-C of FIG. 16(A), respectively.

FIG. 17 is a view showing the eleventh embodiment of the present invention, FIG. 17(A) is a vertical sectional view thereof, FIGS. 17(B) and 17(C) are sectional views taken on lines B-B and C-C of FIG. 17(A), respectively.

FIG. 18 is a view showing the twelfth embodiment of the present invention, FIG. 18(A) is a vertical sectional view thereof, FIGS. 18(B) and 18(C) are sectional views taken on lines B-B and C-C of FIG. 18(A), respectively.

FIG. 19 is a vertical sectional view showing the thirteenth embodiment of the present invention.

FIGS. 20(A), 20(B) and 20(C) are sectional views taken on lines of A-A, B-B and C-C of FIG. 19, respectively.

FIG. 21 is a vertical sectional view showing the fourteenth embodiment of the present invention.

FIG. 22 is a vertical sectional view showing the fifteenth embodiment of the present invention.

FIG. 23 is a view showing the sixteenth embodiment of the present invention, FIG. 23(A) is a vertical sectional view thereof, FIGS. 23(B) and 23(C) are sectional views taken on lines B-B and C-C of FIG. 23(A), respectively.

### BEST MODE FOR CARRYING OUT THE INVENTION

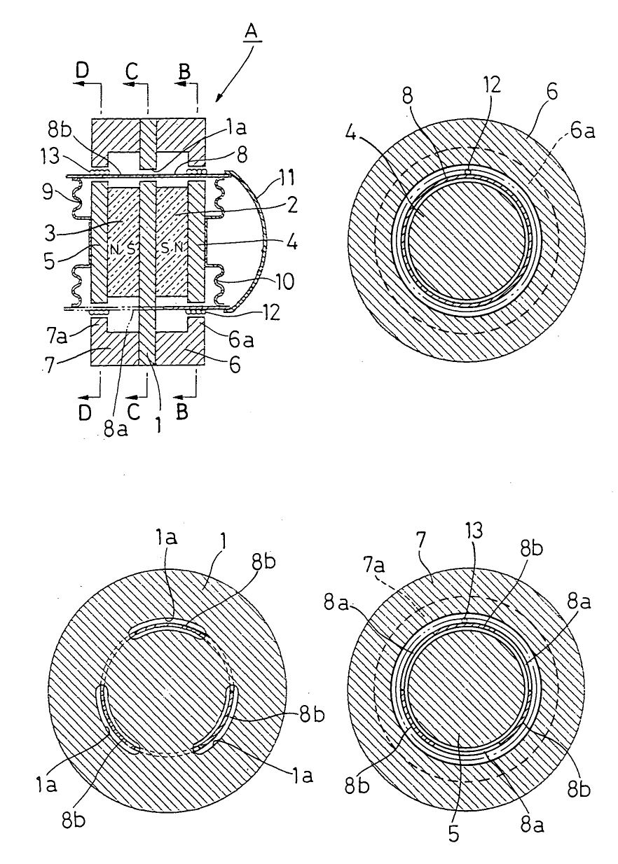

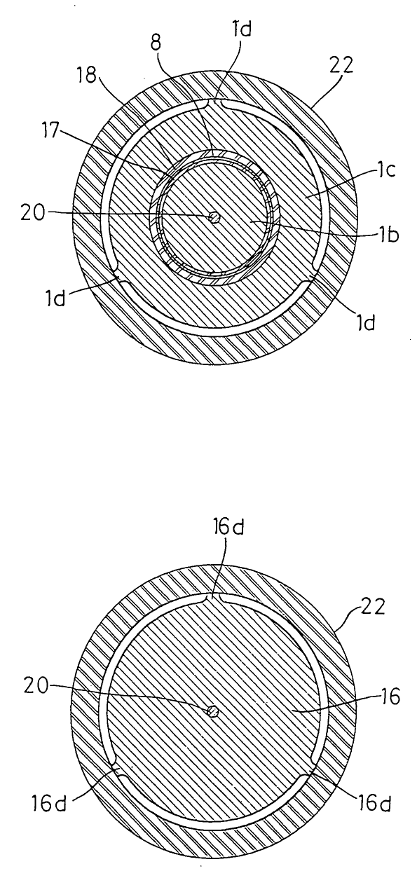

Embodiments of the present invention will be described hereinafter with reference to FIGS. 1 through 23.

FIGS. 1(A) through 1(D) show the first embodiment of the present invention. A speaker A according to this embodiment includes a magnetic shielding member 1. The magnetic shielding member 1 is composed of a magnetic material and formed in a disc-like configuration. A disc-like permanent magnet (first magnetic field feed means) 2 is fixed to a central part of one end of the magnetic shielding member 1, and another disc-like magnet (second magnetic field feed means) 3 is fixed to a central part of the other end face of the magnetic shielding member 1. The permanent magnets 2, 3 have the same outside diameters which are set to be a generally half of the outside diameter of the magnetic shielding member 1. Although the permanent magnets 2, 3 are arranged such that the same polarities (S-polarities in this embodiment) are adjacent with each other, they may also be arranged such that the different polarities are adjacent with each other. Selection of one of those arrangement modes depends on the reason which will be described later. Disc-like magnetic pole pieces 4, 5 composed of a magnetic material are fixed to respective end faces, which are arranged away from each other, of the permanent magnets 2, 3 with their axes aligned with the axes of the permanent magnets 2, 3 and the magnetic shielding member 1. The magnetic pole pieces 4, 5 have the same outside diameters, which are slightly larger than the outside diameters of the permanent magnets 2, 3.

One end faces of the circular cylindrical magnetic pole pieces 6, 7 composed of a magnetic material are fixed to the outer peripheral parts of the opposite end faces of the magnetic shielding member 1. The magnetic pole pieces 6, 7 are arranged with the axes thereof aligned with the axis of the magnetic shielding member 1. Annular protrusions 6a, 7a are formed on the inner peripheral surfaces of the other end parts, which are arranged away from each other, of the magnetic pole pieces 6, 7. The annular protrusions 6a, 7a are spacedly placed opposite the outer peripheral surfaces of the magnetic pole pieces 4, 5, respectively.

A plurality (three in this embodiment) of slits (insertion holes) 1a are formed in the magnetic shielding member 1. Those slits 1a are arranged on a circumference about the axis of the magnetic shielding member 1 and they are arranged generally equidistantly away in the peripheral direction. The inside diameters of the slits 1a are set to be generally equal to the outside diameters of the magnetic pole pieces 4, 5, and the outside diameters of the slits 1a are set to be generally equal to the inside diameters of the annular protrusions 6a, 7a of the magnetic pole pieces 6, 7.

In the above-mentioned construction, the first magnetic circuit is constituted of the permanent magnet 2, the magnetic pole pieces 4, 6 and the magnetic shielding member 1, and the second magnetic circuit is constituted of the permanent magnet 3, the magnetic pole pieces 5, 7 and the magnetic shielding member 1. The magnetic shielding member 1 is used in both the first and second magnetic circuits in this embodiment. However, since the permanent magnets 2, 3 are arranged such that the directions of polarities of the permanent magnets 2, 3 are different from each other, the magnetic force lines of the first magnetic circuit hardly leak to the second magnetic circuit through the magnetic shielding member 1. By the same reason, the magnetic force lines of the second magnetic circuit hardly leak to the first magnetic circuit. In other words, owing to the provision of the magnetic shielding member 1 composed of a magnetic material between the permanent magnets 2, 3, the magnetic force lines of the permanent magnet 2 are prevented from leaking to the second magnetic circuit side, and the magnetic force lines of the permanent magnet 3 are prevented from leaking to the first magnetic circuit side.

The speaker A includes a bobbin 8. The bobbin 8 is composed of an insulating material such as paper, carbon fiber reinforced-paper, or a nonmagnetic material such as aluminum. The bobbin 8 is formed in a circular cylindrical configuration. The inside diameter of the bobbin 8 is set to be slightly larger than the inside diameter of the slit 8, and the outside diameter of the bobbin 8 is set to be slightly smaller than the outside diameter of the slit 1a. The length of the bobbin 8 is set to be larger than the outer dimension between the magnetic pole pieces 4, 5. The bobbin 8 has a plurality (the same number as the slits 1a) of cutout parts 8a extending from a lengthwise intermediate part thereof to the end face on the magnetic pole piece 5 side and formed therein in such a manner as to be generally equidistantly away from each other in the peripheral direction. That part of the bobbin 8 between the every adjacent cutout parts 8a, 8a in the peripheral direction of the bobbin 8 serves as an arm part 8b. The length of the arm part 8b in the peripheral direction is set to be slightly smaller than the length of the slit 1a in the peripheral direction. Accordingly, the arm part 8b can be inserted in the slit 1a with some space.

The bobbin 8 thus constructed is inserted between the magnetic pole piece 4 and the annular protrusion 6a of the magnetic pole piece 6 from one end side (this one end of the bobbin 8 where the arm part 8b is formed is hereinafter referred to as the “rear end part” and the other end is referred to as the “front end part”) where the arm part 8b is formed. The arm part 8b is passed through the slit 1a, and further through the magnetic pole piece 5 and the annular protrusion 7a of the magnetic pole piece 7. Accordingly, the rear end part of the bobbin 8 is projected backward from the magnetic pole pieces 5, 7. The rear end part of the bobbin 8 is supported through a support member 9 disposed between its inner periphery and a central part of the magnetic pole piece 5 such that the bobbin 8 can be displaced in the direction of the axis of the bobbin 8. On the other hand, the front end part of the bobbin 8 is projected outside from between the magnetic pole piece 4 and the annular protrusion 6a of the magnetic pole piece 6. The front end part of the bobbin 8 is supported through a support member 10 disposed between its inner periphery and a central part of the magnetic pole piece 4 such that the bobbin 8 can be displaced in the direction of the axis of the bobbin 8. Accordingly, the bobbin 8 can be displaced in the direction of its axis.

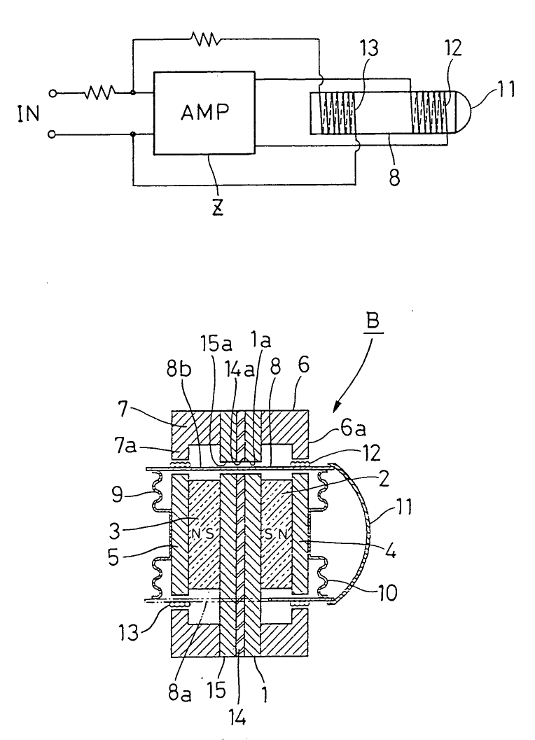

An outer peripheral part of the diaphragm 11 which forms a part of a spherical surface is fixed to the outer periphery of the front end part of the bobbin 8. A voice coil 12 is fixedly wound on a part of the outer peripheral surface of the front end part of the bobbin 8 which part is located slightly rear end side from the diaphragm 11. This voice coil 12 is arranged opposite the annular protrusion 6a of the magnetic pole piece 6. Accordingly, the magnetic force lines caused by the permanent magnet 2 transverses the voice coil 12 from its inside toward its outside, i.e., from the magnetic pole piece 4 side toward the annular projection 6b side. As shown in FIG. 2, opposite end parts of the coil wire which constitutes the voice coil 12 are connected to two output terminals of an amplifier Z, respectively. Accordingly, when a voice electric current flows into the voice coil 12 from the amplifier Z, the voice coil 12 is vibrated in the direction of the axis thereof. In accordance of the vibration of the voice coil 12, the bobbin 8 and the diaphragm 11 are likewise vibrated in the direction of the axis. Vibration of the diaphragm 11 produces a voice.

A detection coil 13 is fixedly wound around the outer peripheral surface of the rear end part of the bobbin 8. This detection coil 13 is arranged opposite the annular protrusion 7a of the magnetic pole piece 7. Accordingly, the magnetic force lines caused by the permanent magnet 3 transverses the detection coil 13 from the inside toward the outside, i.e., from the magnetic pole piece 5 side toward the annular projection 7a side. Thus, in accordance with vibration of the voice coil 12, the bobbin 8 is vibrated. When this causes the detection coil 13 to vibrate in the direction of the axis thereof, a dynamic electric current is generated at the detection coil 13. As shown in FIG. 2, the winding direction of the detection coil 13 is same as the winding direction of the voice coil 12, and the direction of the magnetic force lines transversing the detection coil 13 is also same as the direction of the magnetic force lines transversing the voice coil 12. Accordingly, a dynamic electric current, which is different 180 degrees in phase with respect to the voice electric current inputted in the voice coil 12, is generated at the detection coil 13. This dynamic electric current is negatively fed back to the input side of the amplifier Z.

In order to negatively feed back the dynamic electric current generated at the detection coil 13 to the amplifier Z in the manner as mentioned above, it is necessary to make the dynamic electric current generated at the detection coil 13 to be different 180 degrees in phase with respect to the voice electric current inputted in the voice coil 12. Thus, when the winding direction of the detection coil 13 is same as the winding direction of the voice coil 12, the direction of the magnetic force lines transversing the detection coil 13 is arranged to be same as the direction of the magnetic force lines transversing the voice coil 12, and when the winding direction of the detection coil 13 is reversed to the winding direction of the voice coil 12, the direction of the magnetic force lines transversing the detection coil 13 is arranged to be reverse to the direction of the magnetic force lines transversing the voice coil 12. This is the reason why the arrangement modes of the polarities of the magnets 2, 3 must be determined properly.

In the speaker A thus constructed, when a voice electric current flows in the voice coil 12, magnetic force lines are generated. Since those magnetic force lines flow through the first magnetic circuit which is constituted of the permanent magnet 2, the magnetic pole pieces 4, 6 and the magnetic shielding member 1, the magnetic force lines generated at the voice coil 12 hardly leak to the detection coil 13 side. Accordingly, it hardly occurs that a mutual induction electric current is generated at the detection coil 13, and the amount of feed-back of the dynamic electric current generated at the detection coil 13 is hardly reduced by the mutual induction electric current. Thus, the dynamic characteristics of the speaker can be improved.

Next, other embodiments of the present invention will be described. In the embodiments to be described hereinafter, only the construction which is different from the above embodiment is described, and the same constitutional parts are denoted by same reference numerals, respectively and description thereof is omitted.

FIG. 3 shows the second embodiment of the present invention. In a speaker B according to this embodiment, a spacer 14 and a magnetic pole piece 15 are disposed between the magnetic shielding member 1 and both the permanent magnet 3 and magnetic pole piece 7. The spacer 14 and the magnetic pole piece 15 are fixedly arranged in this order from the magnetic shielding member 1 side toward both the permanent magnet 3 and magnetic pole piece 7 side. The spacer 14 is composed of a nonmagnetic material, and it has the same sectional configuration as the magnetic shielding member 1. A magnetic pole piece 15 is composed of a magnetic material, and it has the same sectional configuration as the magnetic shielding member 1. Slits 14a, 15a having the same configuration and the same dimension as the slit 1a are formed in the spacer 14 and the magnetic pole piece 15, respectively. An arm part 8b of the bobbin 8 is penetrated through the slits 14a, 15a.

Owing to the above-mentioned construction, the speaker B is different from the above-mentioned speaker A in the following three points. Firstly, in the speaker B, the first magnetic circuit is constituted of the permanent magnet 2, the magnetic pole pieces 4, 5, the magnetic shielding member 1 and the second magnetic circuit is constituted of the permanent magnet 3, the magnetic pole pieces 5, 7 and the magnetic pole piece 15. The magnetic shielding member 1 is not commonly used in the first and second magnetic circuits. Secondly, the first and second magnetic circuits are separated from each other by the spacer 14. Thirdly, the magnetic pole piece 15 acts as a magnetic shielding member for preventing entry of magnetism into the detection coil 13 from the first magnetic circuit side. Accordingly, the magnetic force lines generated at the voice coil 12 can be prevented from leaking to the detection coil 13 side more surely. Thus, the dynamic characteristics of the speaker can be much further improved.

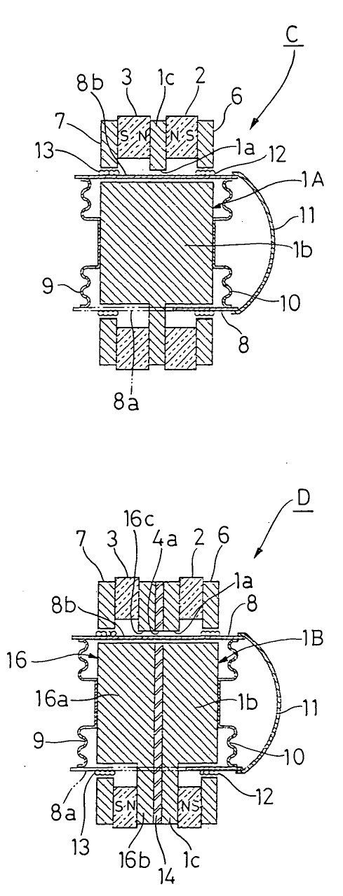

FIG. 4 shows the third embodiment of the present invention. In a speaker C according to this embodiment, a magnetic shielding member 1A composed of a magnetic material is used instead of the magnetic shielding member 1A of the speaker A. This magnetic shielding member 1A is constituted of a solid circular cylindrical part 1b having a circular configuration in section, and a disc-like flange part 1c integrally formed on a central part of the outer peripheral surface of the circular cylindrical part 1b in the direction of the axis thereof. The outside diameter of the circular cylindrical part 1b is formed slightly smaller than the outside diameter of the bobbin 8, and the length of the part 1b is formed slightly shorter than the length of the bobbin 8. The circular cylindrical part 1b is inserted in the bobbin 8. The flange part 1c is arranged coaxial with the circular cylindrical part 1b, and it is formed larger in diameter than the bobbin 8. A slit 1a is formed in a basal end part of the flange part 1c. One end faces of ring-like permanent magnet (first magnetic field feed means) 2 and permanent magnet (second magnetic field feed means) 3 are fixed respectively to opposite end faces of the flange part 1c located on the outer periphery side from the slit 1a. Ring-like magnetic pole pieces 6, 7 are fixed respectively to the other end faces of the permanent magnets 2, 3. The circular cylindrical part 1b, the permanent magnets 2, 3, and the magnetic pole pieces 6, 7 are arranged with their axes aligned with each other. The magnetic pole piece 6 is arranged such that its inner peripheral surface is opposed to a rear end part of the outer peripheral surface of the circular cylindrical part 1b. The magnetic pole piece 7 is arranged such that its inner peripheral surface is opposed to the distal end part of the outer peripheral surface of the circular cylindrical part 1b. As apparent from this, the circular cylindrical part 1b also serves as the magnetic pole pieces 4, 5 in the speaker A, and support members 9, 10 are fixed to the opposite end faces of the circular cylindrical part 1b, respectively. The voice coil 12 and the detection coil 13 are disposed at places opposite to the magnetic pole pieces 6, 7 of the bobbin 8, respectively. In this speaker C, the first magnetic circuit is constituted of the permanent magnet 2, the flange part 1c and a half on the front end side of the circular cylindrical part 1b of the magnetic shielding member 1A and the magnetic pole piece 6, and the second magnetic circuit is constituted of the permanent magnet 3, the flange part 1c and a half on the front end side of the circular cylindrical part 1b of the magnetic shielding member 1A and the magnetic pole piece 7.

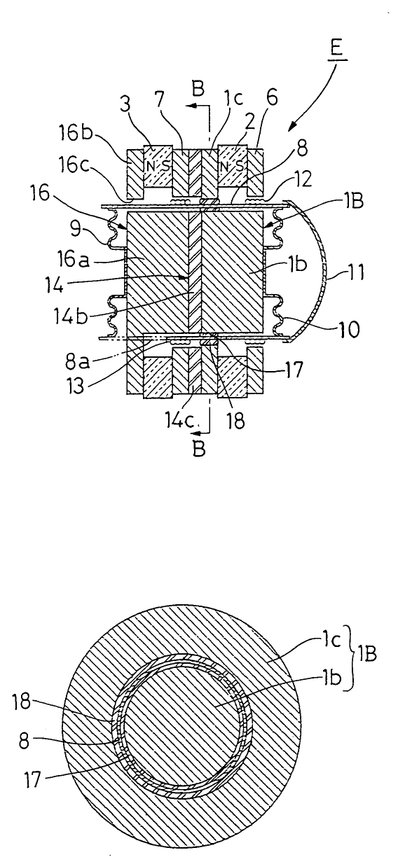

FIG. 5 shows the fourth embodiment of the present invention. A speaker D according to this embodiment is constituted of a combination of the speaker B shown in FIG. 3 and the speaker C shown in FIG. 4. That is, in this speaker D, the magnetic shielding member 1A shown in FIG. 4 is divided into two parts at the central part in the direction of its axis, i.e., at the central part in the widthwise direction of the flange part 1c. And its part on the voice coil 12 side serves as a magnetic shielding member 1B and its part on the detection coil 13 side serves as a magnetic circuit constituting member (magnetic pole piece) 16. Of course, the magnetic shielding member 1B includes a circular cylindrical part 1b and a flange part 1c. On the other hand, the magnetic circuit constituting member 16 has a configuration symmetrical with the magnetic shielding member 1B, and it includes a circular cylindrical part 16a and a flange part 16b which have the same configurations and sizes as the circular cylindrical part 1b and the flange part 1c of the magnetic shielding member 1B, respectively. A slit 16c for allowing an arm part 8b of a bobbin 8 to pass therethrough is formed in the flange part 16b.

In this speaker D, a spacer 14 composed of a nonmagnetic material is disposed between the magnetic shielding member 1B and the magnetic circuit constituting member 16. In addition, the magnetic circuit constituting member 16 functions as a magnetic shielding member in the same manner as the magnetic pole piece 15 of the speaker B. Accordingly, in the speaker D according to this embodiment, the dynamic characteristics of the speaker can be further improved than the speaker C.

FIG. 6 shows the fifth embodiment of the present invention. In a speaker E according to this embodiment, a circular cylindrical part (inner part) 1b and a flange part (outer part) 1c of a magnetic shielding member 1B is separated from each other, and an annular gap is formed between the outer peripheral surface of the circular cylindrical part 1b and the inner peripheral surface of the flange part 1c. A bobbin 8 is arranged in such a manner as to pass through the annular-gap. Magnetic fluids 17, 18 are filled in a gap formed between the inner peripheral surface of the bobbin 8 and the outer peripheral surface of the circular cylindrical part 1b and a gap formed between the outer peripheral surface of the bobbin 8 and the inner peripheral surface of the flange part 1c, respectively. The lengths of the magnetic fluids 17, 18 in the direction of the axis of the circular cylindrical part 1b are set to be generally same as the width of the flange part 1c.

The spacer 14 is also divided into two parts, an inner plate part 14b on the inner periphery side and a ring-like outer plate part 14c on the outer periphery side as in the case with the magnetic shielding member 1B. The inner plate part 14b has the same outside diameter as the circular cylindrical part 1b and the former is coaxially arranged with the latter. The outer plate part 14c has the same outside diameter and the same inside diameter as the flange part 1c and the former is coaxially arranged with the latter. The bobbin 8 is passed through an annular gap formed between the inner plate part 14b and the outer plate part 14c with a clearance.

A flange part 16b of a magnetic circuit constituting member 16 is formed on the end part at the opposite side to the magnetic shielding member 1B. In correspondence with this, a magnetic pole piece 7 is arranged on the magnetic shielding member 1B side in such a manner as to be adjacent to the spacer 14. A detection coil 13 is wound around the outer periphery of the bobbin 8 located opposite the magnetic pole piece 7.

The inner plate part 14b of the spacer 14 and the circular cylindrical part 1b of the magnetic shielding member 1B are sequentially fixed by fixing means such as an adhesive agent. Likewise, a permanent magnet 3, the magnetic pole piece 7, the outer plate part 14b of the spacer 14, the flange part 1c of the magnetic shielding member 1B, a permanent magnet 2 and a magnetic pole piece 6 are sequentially fixed to the end face facing the magnetic shielding member 1B side of the spacer 14 by fixing means such as an adhesive agent. All the remaining construction is same as the speaker D.

In the speaker E according to this embodiment, since the magnetic fluids 17, 18 are filled respectively between the circular cylindrical part 1b of the magnetic shielding member 1B and the bobbin 8 and between the flange part 1c of the magnetic shielding member 1B and the bobbin 8, the magnetic force lines caused by the voice coil 12 can be more surely prevented from leaking to the detection coil 13 side. However, the magnetic fluids 17, 18 are not mandatory.

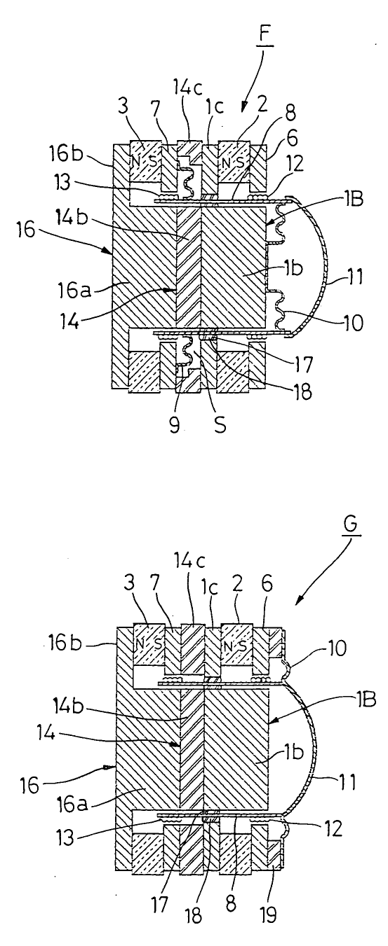

FIG. 7 shows the sixth embodiment of the present invention. A speaker F according to this embodiment is different from the speaker E in the following points. That is, in the speaker F, the inside diameter of an outer plate part 14c of a spacer 14 is formed sufficiently larger than the outside diameter of a bobbin 8, and an annular space S is defined by the bobbin 8, the outer plate part 14c, a flange part 1c of a magnetic shielding member 1B and a magnetic pole piece 7. An annular support member 9 is arranged in the space S. The outer peripheral part of this support member 9 is fixed to the magnetic pole piece 7, and the inner peripheral part is fixed to an intermediate part of the bobbin 8. Accordingly, since it is not necessary to pass the bobbin 8 through a flange part 16a of a magnetic circuit constituting member 16, the entire length of the bobbin 8 can be reduced to that extent. Moreover, since the bobbin 8 does not pass through the flange part 16b of the magnetic circuit constituting member 16, no slit is required to form in the flange part 16b and no cutout is required to form in the bobbin 8, either. Therefore, the manufacturing cost can be reduced to that extent.

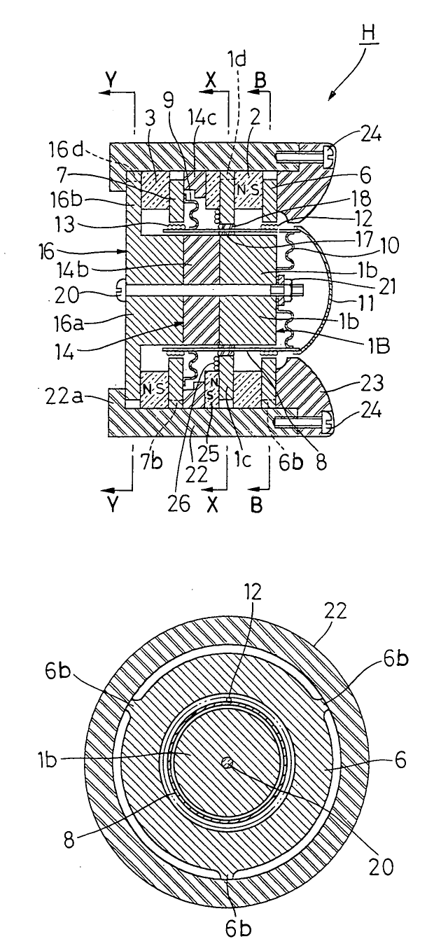

FIG. 8 shows the seventh embodiment of the present invention. In a speaker G according to this embodiment, a diaphragm 11 is integrally formed on the inner peripheral part of a support member 10. The outer peripheral part of the support member 10 is fixed to an annular spacer 19 which is coaxially fixed to an end face of a magnetic pole piece 6. Likewise, one end part of a bobbin 8 is fixed to the outer peripheral part (boundary part between the support member 10 and the diaphragm 11) of the diaphragm 11. The other end part of the bobbin 8 is a free end which is not supported by anything. That is, the bobbin 8 is supported by the support member 10 in a cantilever fashion. Accordingly, a space S is not formed in this speaker G, and a support member 9 is not used, either. All the remaining construction is same as the speaker F.

FIGS. 9 through 11 show the eighth embodiment of the present invention. A speaker H according to this embodiment is obtained by more concretely designing the speaker F shown in FIG. 7 so that it can be put into actual use. For this purpose, a ring-like magnetic circuit interference preventing magnet 25 is fixedly arranged between an outer plate part 14c of a spacer 14 and a flange part 1c of a magnetic shielding member 1B in such a manner as to be coaxial with the outer plate part 14c and the flange part 1c. This magnet 25 is arranged such that the direction of polarities of the magnet 25 is different from the direction of the polarities of permanent magnets 2, 3. Accordingly, the magnet 25 prevents a magnetic circuit caused by a magnet 2 and a magnetic circuit caused by a magnet 3 from interfering with each other. Of all the end face area of the flange part 1c where the magnet 25 is fixed, a part of the area on the inner periphery side of the magnet 25 is provided with a correction coil 26 which is fixed thereto in such a manner as to be coaxial with the flange part 1c. This correction coil 26 is adapted to prevent an electric current from inducing (mutual induction) into the detection coil 13 which would otherwise be caused by a voice electric current flowing to the voice coil 12. The correction coil 26 is connected to the voice coil 12 or the detection coil 13. This will be described later.

Instead of the adhesive agent or with the aid of the adhesive agent, an inner plate part 14b of the spacer 14 and a circular cylindrical part 1b of the magnetic shielding member 1B are fixed to a magnetic circuit constituting member 16 by a bolt 20 which is passed through the central parts of the magnetic circuit constituting member 16, the spacer 14 and the magnetic shielding member 1B and a nut 21 which is threadingly engaged with the bolt 20. A resin-made cylindrical body 22 is externally fitted to the outside of the magnetic shielding member 1B, the magnetic circuit constituting member 16, the spacer 14, the permanent magnets 2, 3, the magnetic pole pieces 6, 7 and the magnetic circuit interference preventing magnet 25. In other words, the magnetic shielding member 1B, the magnetic circuit constituting member 16, the spacer 14, the permanent magnets 2, 3, the magnetic pole pieces 6, 7 and the magnet 25 are fitted to the inner periphery of the cylindrical body 22, thereby the respective members are coaxially retained. As shown in FIGS. 9(B), 10 and 11, the outer peripheral surfaces of the flange parts 1c, 16b of the magnetic shielding member 1B and the magnetic circuit constituting member 16 and the outer peripheral surfaces of the magnetic pole pieces 6, 7 are provided with at least three small projections 1d, 16d, 6b, 7b, respectively. Each small projections 1d, 16d, 6b, 7b are equally spacedly arranged in the peripheral direction. By bringing the small projections 1d, 16d, 6b, 7b into contact with the inner peripheral surfaces of the cylindrical body 22, respectively, the magnetic shielding member 1B, the magnetic circuit constituting member 16 and the magnetic pole pieces 6, 7 are fitted to the inner periphery of the cylindrical body 22. An annular protrusion 22a protruding toward the inner periphery side is formed on one end part of the cylindrical body 22. An annular resin-made front surface cover 23 is fixed to the other end part of the cylindrical body 22 by a bolt 24. This front surface cover 23 is in contact with the magnetic pole piece 6, and the protrusion 23a is in contact with the flange part 16b of the magnetic circuit constituting member 16. Owing to this arrangement, the magnetic shielding member 1B, the magnetic circuit constituting member 16, the spacer 14, the permanent magnets 2, 3, the magnetic pole pieces 6, 7 and the magnet 25 which are fitted to the inner periphery of the cylindrical body 22, are prevented from escaping from the cylindrical body 22.

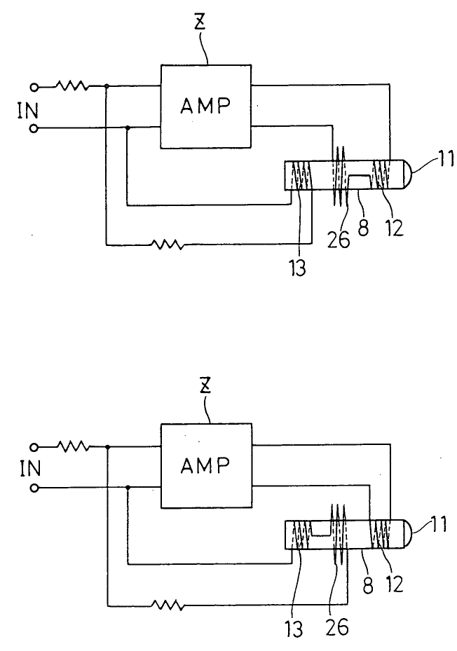

FIG. 12 shows one example of a schematic construction of a speaker apparatus in which the speaker H including the voice coil 12, the detection coil 13 and the correction coil 20 is used. In this speaker apparatus, the voice coil 12 and the correction coil 26 are connected with each other in series. One end parts of the voice coil 12 and the correction coil 26 are connected to output terminals of an amplifier Z, respectively. Moreover, the voice coil 12 and the correction coil 26 are mutually reversely wound. The detection coil 13 is wound in the same direction as the voice coil 12.

In the speaker apparatus thus construction, since the directions of the magnetic force lines generated at the coils 12, 26 are reverse, the magnetic force lines generated at the correction coil 26 prevent or diminish the magnetic force lines generated at the voice coil 12 from reaching the detection coil 13 side. Accordingly, this arrangement can further enhance the dynamic characteristics of the speaker H with the help of the magnetic shielding member 1B.

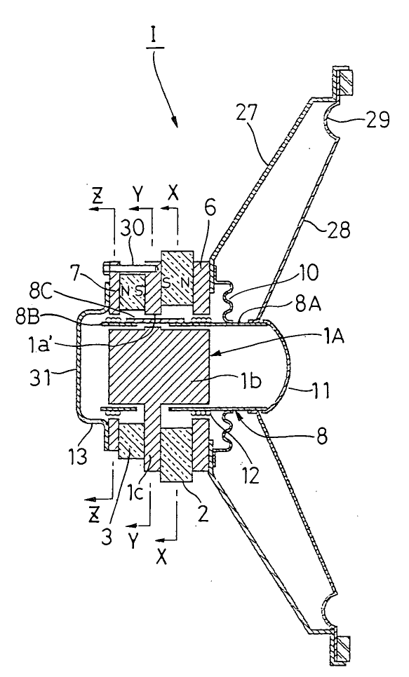

FIG. 13 shows another example of a schematic construction of a speaker apparatus in which the speaker H is used. In this speaker apparatus, a detection coil 13 and a correction coil 26 are connected to each other in series. One end parts of the detection coil 13 and the correction coil 26 are connected to input terminals of an amplifier Z, respectively. The winding direction of the detection coil 13 and the winding direction of the correction coil 26 are reversed. The winding direction of the voice coil 12 and the winding direction of the detection coil 13 are same. Opposite end parts of the voice coil 12 are connected to output terminals of an amplifier Z, respectively.

In this speaker apparatus, even if a mutual conduction electric current should be generated in the detection coil 13 by a mutual conduction between the voice coil 12 and the detection coil 13, this electric current would be offset by an electric current which is generated in the correction coil 26 under the effect of mutual conduction between the voice coil 12 and the correction coil 26. Accordingly, the feedback amount of dynamic electric current flowing in the detection coil 13 would never be reduced. Thus, the dynamic characteristics of the speaker H can further be improved as in the case with the speaker apparatus shown in FIG. 12.

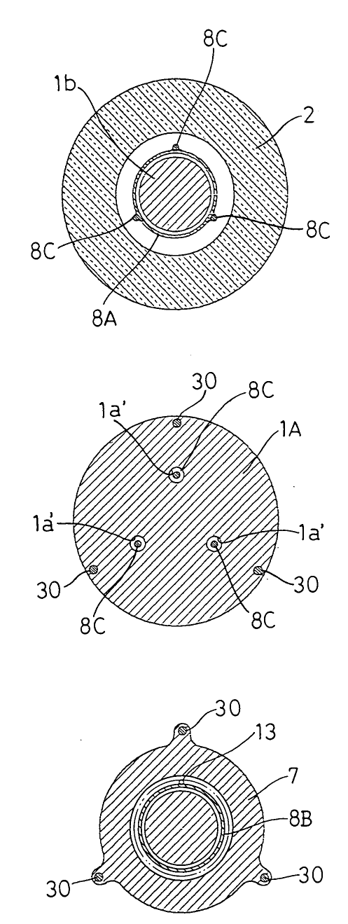

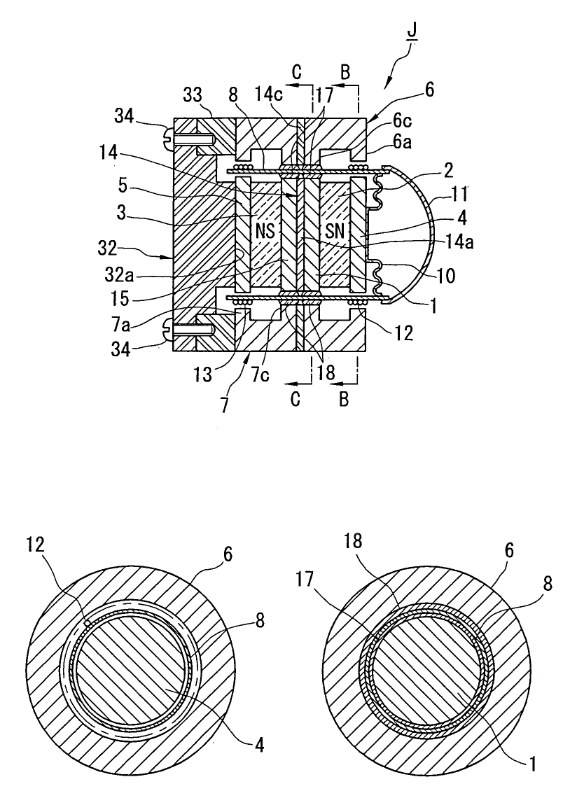

FIGS. 14 and 15 show the ninth embodiment of the present invention. A speaker I according to this embodiment is obtained by modifying the speaker C shown in FIG. 4 such that it can suitably be used as a low frequency speaker. An end part on the reduced diameter side of a cone member 27, which is enlarged in diameter toward forward, is fixed to the front surface of a magnetic pole piece 6. An end part on the enlarged diameter side of a cone-like second diaphragm (diaphragm) 28 is supported by an end part on the enlarged diameter side of the cone member 27 through a support member 29 such that the second diaphragm 28 can be vibrated in a back and forth direction. The end part on the reduced diameter side of the second diaphragm 28 is fixed to a bobbin 8.

This speaker I is different from the speaker C shown in FIG. 4 in the following points. That is, the bobbin 8 is divided into two parts, one is a front part 8A which is situated on a front side from a permanent magnet 2 and the other is a rear part 8B which is situated on a rear side from the permanent magnet 3. The front part 8A and the rear part 8B are arranged with their axes aligned, and they are connected to each other by a plurality of connection shafts 8C which are spacedly arranged in the peripheral direction. The connection shaft 8C is inserted in an insertion hole 1a′, instead of the slit 1a, which is formed in a flange part 1c. As shown in FIG. 15(B), the length in the peripheral direction of the insertion hole 1a′ is extensively smaller than that of the slit 1a. Accordingly, the magnetic shielding member 1A can be enhanced in magnetic shielding effect. The flange 1c and the magnetic pole piece 7 are pressed against the permanent magnet 3 by a bolt 30, so that the flange 1c, the permanent magnet 3 and the magnetic pole piece 7 are mutually fixed. The magnetic pole piece 7 is provided with a dust preventing cover 31 at its end face on the opposite side to the magnet 3.

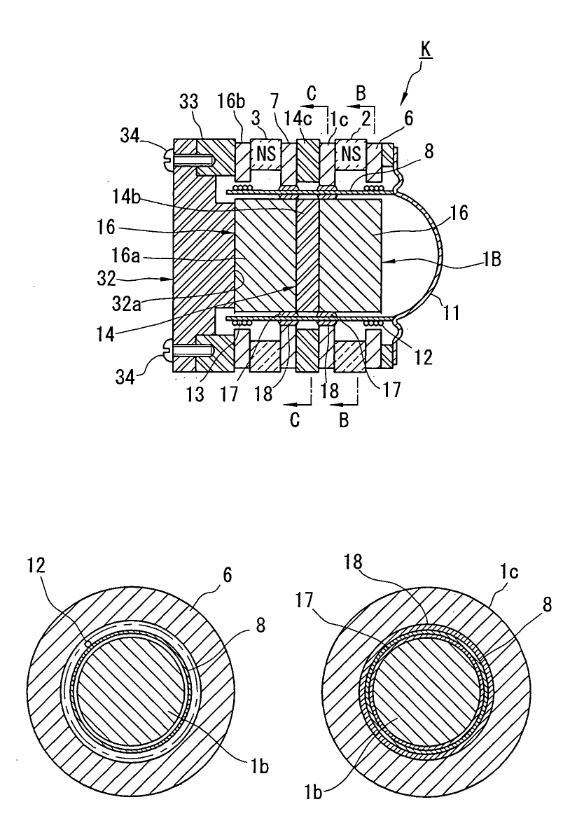

FIGS. 16(A), 16(B) and 16(C) show the tenth embodiment of the present invention. In a speaker J according to this embodiment, a disc-like retaining member 32, which is composed of a nonmagnetic material such as aluminum, is used. A protrusion 32a having a circular configuration in section is formed on a central part of one end face of the retaining member 32. A magnetic pole piece 5, a permanent magnet 3, a magnetic pole piece 15, an inner plate part 14b of a spacer 14, a magnetic shielding member 1, a permanent magnet 2 and a magnetic pole piece 4, which are coaxially arranged with the protrusion 32a, are sequentially fixed to the front end face of the protrusion 32a by suitable means such as an adhesive agent. The magnetic pole piece 5, the permanent magnet 3, the magnetic pole piece 15, the inner plate part 14b of the spacer 14, the magnetic shielding member 1, the permanent magnet 2 and the magnetic pole piece 4 are formed smaller in diameter than the inside diameter of a bobbin 8, and the bobbin 8 is externally fitted to the outside of them with a space. Magnetic fluids 17 are disposed respectively between the outer peripheral surface of the magnetic shielding member 1 and the inner peripheral surface of the bobbin 8 and between the outer peripheral surface of the magnetic pole piece 15 and the inner peripheral surface of the bobbin 8. The bobbin 8 is fixed to the magnetic pole piece 4 in a cantilever manner through a support member 10 in the same manner as the speaker B shown in FIG. 7, for example.

A retaining ring 33, which is coaxially arranged with the retaining member 32, is fixed to the outer peripheral part of one end face of the retaining member 32 by bolts 34. A magnetic pole piece 7, an outer plate part 14c of the spacer 14 and a magnetic pole piece 6, which are coaxially arranged with the retaining member 32, are sequentially fixed to an end face of a retaining ring 33, which faces the same direction as the front end face of the protrusion 32, by means such as an adhesive agent. The inside diameters of the magnetic pole piece 7, the outer plate part 14c of the spacer 14 and the magnetic pole piece 6 are formed larger than the outside diameter of the bobbin 8. Annular protrusions 7a, 7b are formed on one and the other end part of the inner peripheral surface of the magnetic pole piece 7. The annular protrusion 7a is disposed opposite to the outer peripheral surface of the magnetic pole piece 5 through the bobbin 8, and the annular protrusion 7c is disposed opposite to the outer peripheral surface of the magnetic pole piece 15 through the bobbin 8. A detection coil 13 is disposed at the outer peripheral surface of the bobbin 8 which is disposed opposite to the annular protrusion 7a. A magnetic fluid 18 is disposed in a gap formed between the inner peripheral surface of the annular protrusion 7c and the outer peripheral surface of the bobbin 8. Annular protrusions 6a, 6c are formed on one and the other end part of the inner peripheral surface of the magnetic pole piece 6, respectively. The annular protrusion 6a is disposed opposite to the outer peripheral surface of the magnetic pole piece 4 through the bobbin 8, and the annular protrusion 6c is disposed opposite to the outer peripheral surface of the magnetic shielding member 1 through the bobbin 8. A voice coil 12 is disposed at the outer peripheral surface of the bobbin 8 which is disposed opposite to the annular protrusion 6a. The magnetic fluid 18 is disposed in a gap formed between the inner peripheral surface of the annular protrusion 6c and the outer peripheral surface of the bobbin 8.

In this speaker J, the magnetic shielding member 1 is formed smaller in diameter than the bobbin 8. However, since the magnetic shielding member 1 is magnetically continuous with the annular protrusion 6c of the magnetic pole piece 6 through the magnetic fluids 17, 18, the end part of the magnetic pole piece 6, which is disposed opposite to the magnetic shielding member 1, is functions as a part of the magnetic shielding member 1. Accordingly, this speaker J can also be improved in dynamic characteristics as in the above-mentioned various speakers A through I.

FIGS. 17(A), 17(B) and 17(C) show the eleventh embodiment of the present invention. The speaker K according to this embodiment is a modification of the speaker G shown in FIG. 8. A retaining member 32 and a retaining ring 33 are also used in this speaker K. A circular cylindrical part 16a of a magnetic circuit constituting member 16, an inner plate part 14b of a spacer 14 and a circular cylindrical part 1b of a magnetic shielding member 1B, which are coaxially arranged with the retaining member 32, are sequentially fixed to the front end face of the protrusion 32a of the retaining member 32 by means such as an adhesive agent. A flange part 16b of a magnetic circuit constituting member 16, a permanent magnet 3, a magnetic pole piece 7, an outer plate part 14c of the spacer 14, a flange part 1c of the magnetic shielding member 1B, a permanent magnet 2 and a magnetic pole piece 6, which are coaxially arranged with the retaining member 32, are sequentially fixed to the retaining ring 33 by means such as an adhesive agent. A detection coil 13 and a voice coil 12 are disposed at areas opposing the flange part 16b and the magnetic pole piece 6, respectively, of the outer peripheral surface of the bobbin 8. Magnetic fluids 17 are disposed respectively between the opposing surfaces of the flange part 1c and the bobbin 8 and between the opposing surfaces of the magnetic pole piece 7 and the bobbin 8. Magnetic fluids 18 are disposed respectively between the opposing surfaces of the bobbin 8 and the circular cylindrical part 1b and between the opposing surfaces of the bobbin 8 and the circular cylindrical part 16a, which circular cylindrical part 1b and the circular cylindrical part 16a are in correspondence with the flange part 1c and the magnetic pole piece 7, respectively.

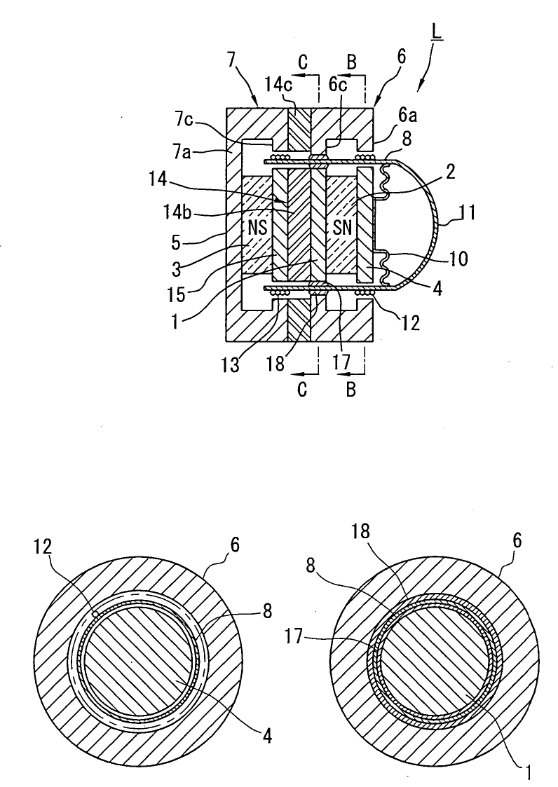

FIGS. 18(A), 18(B) and 18(C) show the twelfth embodiment of the present invention. A speaker L according to this embodiment is obtained by further simplifing the structure of the speaker J shown in FIG. 16. For this purpose, the magnetic pole piece 5 is integrally formed with the magnetic pole piece 7. That is, the outer peripheral part of the magnetic pole piece 5 and the annular protrusion 7a of the magnetic pole piece 7 are continuously integrally formed. The permanent magnet 3, the magnetic pole piece 15, the inner plate part 14b of the spacer 14, the magnetic shielding member 1, the permanent magnet 2 and the magnetic pole piece 4 are sequentially fixed to a central part of one end face of the magnetic pole piece 5 by means such as an adhesive agent. The outer plate part 14c of the spacer 14 and the magnetic pole piece 6 are sequentially fixed to the outer peripheral part of one end face of the magnetic pole piece 7. Since the magnetic pole piece 5 and the magnetic pole piece 7 are integrated, the bobbin 8 merely passes between the magnetic pole piece 15 and the annular protrusion 7c of the magnetic pole piece 7 without passing between the magnetic pole pieces 5, 7. A detection coil 13 is disposed at the outer peripheral surface of the bobbin 8 opposing the annular protrusion 7c of the magnetic pole piece 7.

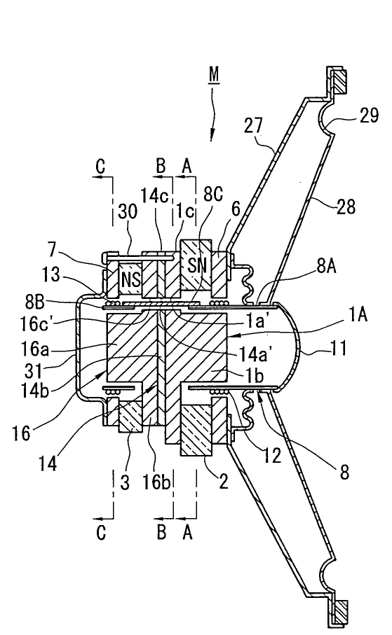

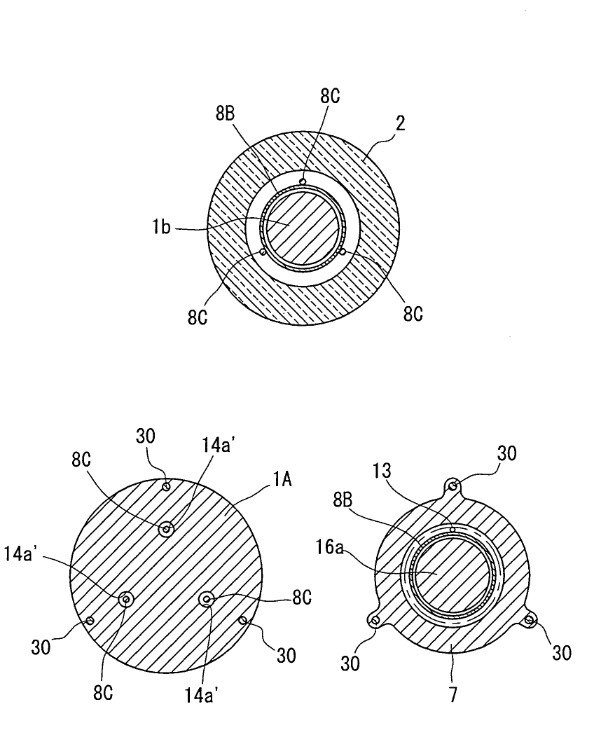

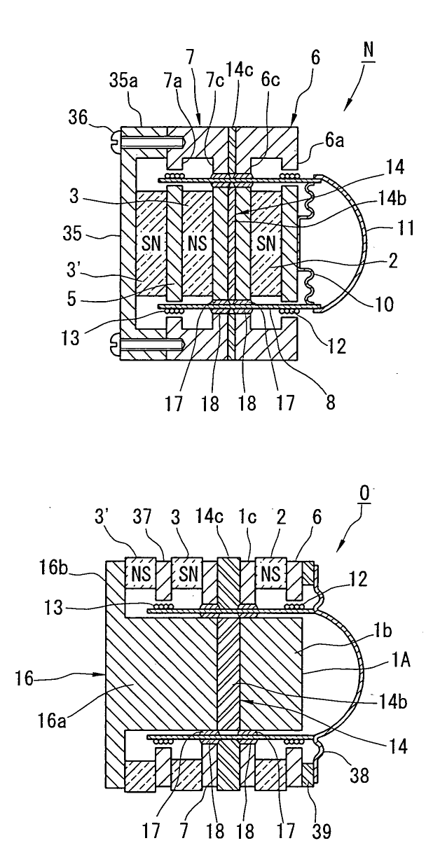

FIGS. 19 and 20(A) through 20(C) show the thirteenth embodiment of the present invention. A speaker M according to this embodiment is a modification of the speaker I shown in FIGS. 14 and 15. That is, a rear end part of a circular cylindrical part 1b of a magnetic shielding member 1A is located at an intermediate part of a connection shaft part 8C of a bobbin 8. A spacer 14, a magnetic circuit constituting member 16, a permanent magnet 3 and a magnetic pole piece 7 are fixed to rear end surfaces of the circular cylindrical part 1b and a flange part 1c of the magnetic shielding member 1A by bolts 30. Insertion holes 14a′, 16c′ for allowing the passage of the connection shaft part 8C of the bobbin 8 are formed in an outer plate part 14c of the spacer 14 and a flange part 16b of the magnetic circuit constituting member 16, respectively. All the remaining construction is same as the speaker I shown in FIGS. 14 and 15.

FIG. 21 shows the fourteenth embodiment of the present invention. A speaker N according to this embodiment is an improvement of the speaker J shown in FIG. 16. In this speaker N, a magnetic pole piece 35 composed of a magnetic material is used instead of the retaining member 32 composed of a nonmagnetic material. The magnetic pole piece 35 has a disc-like configuration, and it is coaxially arranged with the magnetic pole piece 7. An annular protrusion 35a protruding toward the magnetic pole piece 7 side is formed on the outer peripheral part of one end face opposing the magnetic pole piece 7 of the magnetic pole piece 35. The protrusion 35a is brought into abutment with the magnetic pole piece 7 and in the condition, a bolt 36 is tightened to fix the magnetic pole piece 35 to the magnetic pole piece 7. A permanent magnet 3′ having the generally same configuration and same dimension as the permanent magnet 3 are disposed between the magnetic pole piece 35 and the magnetic pole piece 5. Opposite end faces of this permanent magnet 3′ are pressed and contacted with the magnetic pole pieces 5, 35, respectively. The direction of the polarities of the permanent magnet 3′ is reversed to that of the magnet 3. Accordingly, the magnetic force of the permanent magnet 3′ moves from the magnetic pole piece 5 toward the annular protrusion 7a of the magnetic pole piece 7 after transversing the detection coil 13. Thus, the magnetic force lines transversing the detection coil 13 can be enlarged to that extent and so, the output of the detection coil 13 can be increased. In case the permanent magnet 3′ is used, the permanent magnet 3 may be omitted. In that case, the permanent magnet 3′ functions as the second magnetic field feed means.

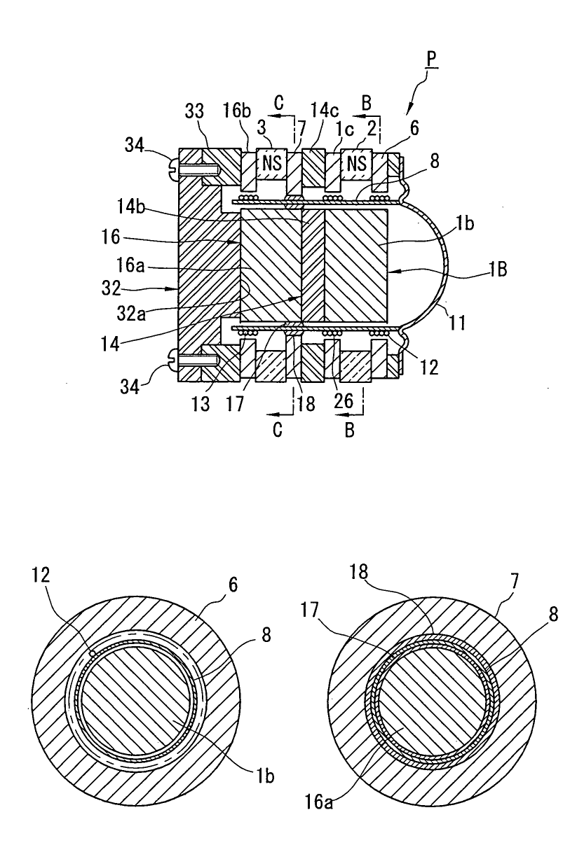

FIG. 22 shows the fifteenth embodiment of the present invention. A speaker O according to this embodiment is an improvement of the speaker E shown in FIG. 6. In this speaker O, a magnetic pole piece 37 and a permanent magnet 3′ are disposed between a permanent magnet 3 and a flange part 16b of a magnetic circuit constituting member 16. A detection coil 13 is disposed at the outer peripheral part of a bobbin 8 opposing the magnetic pole piece 37. The direction of the polarities of the permanent magnet 3′ are reversed to those of the permanent magnet 3. Accordingly, the magnetic force lines passing through the detection coil 13 are not only those caused by the permanent magnet 3 but also those caused by the permanent magnet 3′. Thus, the magnetic force lines passing through the detection coil 13 can be enlarged by the portion of the permanent magnet 3′., and thereby, the output of the detection coil 13 can be increased. Owing to the arrangement in which the detection coil 3 is disposed at the outer peripheral part of the bobbin 8 opposing the magnetic pole piece 37, magnetic fluids 18, 17 are disposed respectively at a gap formed between the inner peripheral surface of the magnetic pole piece 7 and the outer peripheral surface of the bobbin 8 and at a gap formed between the inner peripheral surface of the bobbin 8 and a circular cylindrical part 16a of a magnetic circuit constituting member 16 located at the same position in the axial direction as the magnetic pole piece 7. The bobbin 8 is fixed to a magnetic pole piece 6 through a support member 38 and a bracket 39.

FIG. 23 shows the sixteenth embodiment of the present invention. A speaker P according to this embodiment is an improvement of the speaker K shown in FIG. 17. In this speaker P, no magnetic fluids 17, 18 are disposed between a flange part 1c of a magnetic shielding member 1B and the outer peripheral surface of a bobbin 8 and between a circular cylindrical part 1b of the magnetic shielding member 1B and the inner peripheral surface of the bobbin 8, and a correction coil 26 is wound around the outer peripheral surface of the bobbin 8 opposing the inner peripheral surface of the flange part 1c. The winding direction of this correction coil 26 is reversed to the winding direction of the voice coil 26, and the correction coil 26 is connected to the voice coil 12 in series. All the remaining construction is same as the speaker K shown in FIG. 17.

According to the speaker P thus constructed, since the correction coil 26 which winding direction is reversed to that of the voice coil 12 and which is connected to the voice coil 12 in series, is disposed between the voice coil 12 and the detection coil 13, the magnetic force lines which the correction coil 26 makes in accordance with the flow of a voice electric current offsets or diminishes the magnetic force lines which the voice coil 12 makes. Accordingly, a generating amount of electric current generated at the detection coil 13 under the effect of mutual induction occurred between the detection coil 13 and the voice coil 12, can be reduced. Moreover, since the direction (polarities) of passage of the magnetic circuit caused by the permanent magnet 2 through the correction coil 26 is reversed to direction of passage through the voice coil 12, the force of the correction coil 26 for moving the bobbin 8 in accordance with the voice electric current is same in direction as the force of the voice coil 12 for moving the bobbin 8. Thus, the bobbin 8 can be moved by a large force, and the output of the speaker P can be increased.

The present invention is not limited to the above embodiments but many changes and modifications can be made in accordance with necessity.

For example, although the voice coil 12 is disposed at the front end part of the bobbin 8 and the detection coil 13 are disposed at the rear part, respectively, the arrangement can be made in the reverse way, i.e., the detection coil 13 may be disposed at the front end part of the bobbin 8 and the voice coil 12 may be dispose at the rear end part, respectively.

Moreover, the second diaphragm may be disposed at any one of the speakers A, B, D through H, J through L, N and O.

### Industrial Applicability

A speaker according to the present invention can be utilized as a speaker of audio devices for which high quality of sound is desirable.

1.-5. (Canceled)

6. A speaker comprising a voice coil for driving a diaphragm, a detection coil connected to said voice coil with the axis thereof generally aligned with that of said voice coil and in a manner capable of moving in the axial direction in unison with said voice coil, a first magnetic field feed means for feeding a magnetic field to said voice coil, and a second magnetic field feed means for feeding a magnetic field to said detection coil, wherein
said speaker further comprising a cylindrical bobbin one end of which is attached with said diaphragm and a magnetic shielding member composed of a magnetic material, said voice coil and said detection coil being spacedly arranged on an outer periphery of said bobbin in the direction of the axis of said bobbin, said magnetic shielding member being disposed between said voice coil and said detection coil and adapted to prevent a magnetic force line generated by said voice coil from being bound for said detection coil side.

7. The speaker according to claim 6, wherein said bobbin is provided with a plurality of cutout parts which are spacedly arranged thereon in the peripheral direction and extending from an intermediate part between said voice coil and said detection coil to the other end face of said bobbin, thereby an arm part being formed between every two adjacent cutout parts in the peripheral direction, said magnetic shielding member being disposed between said voice coil and said detection coil in the direction of the axis of said bobbin, the same number of insertion holes as the number of said arm parts being formed in said magnetic shielding member, said arm parts being inserted in the corresponding insertion holes with spaces, respectively.

8. The speaker according to claim 6, wherein said magnetic shielding member and a magnetic pole piece constituting a part of a magnetic circuit for said detection coil are arranged in adjacent relation in the direction of the axis of said voice coil, and a spacer composed of a nonmagnetic material is disposed between said magnetic shielding member and said magnetic pole piece.

9. The speaker according to claim 6, wherein said magnetic shielding member includes an annular outer member disposed at the outside of said bobbin with a space formed between said outer member and an outer peripheral surface of said bobbin and an inner member disposed at the inside of said bobbin with a space formed between said inner member and an inner peripheral surface of said bobbin in such a manner as to oppose said outer member with said bobbin disposed therebetween, a magnetic fluid being disposed between said outer member and said bobbin and another magnetic fluid between said inner member and said bobbin, respectively.

10. The speaker according to claim 6, wherein a correction coil for reducing an induction current induced to said detection coil in accordance with variation of current flowed into said voice coil is disposed generally coaxially with said voice coil and said detection coil, said correction coil, said correction coil is connected with said voice coil in series.
